(19) United States
(12) Patent Application Publication
(10) Pub. No.: US 2024/0094871 A1
(43) Pub. Date: Mar. 21, 2024

(54) SPLIT SCREEN APPLICATION MATCHING METHOD OF TERMINAL, APPARATUS, ELECTRONIC DEVICE AND STORAGE MEDIUM

(71) Applicant: SAMSUNG ELECTRONICS CO., LTD., Suwon-si (KR)

(72) Inventor: Yiwen YANG, Guangzhou (CN)

(73) Assignee: SAMSUNG ELECTRONICS CO., LTD., Suwon-si (KR)

(21) Appl. No.: 18/371,253

(22) Filed: Sep. 21, 2023

Related U.S. Application Data
(63) Continuation of application No. PCT/KR23/14385, filed on Sep. 21, 2023.

(30) Foreign Application Priority Data
Sep. 21, 2022 (CN) 202211152788.9

(51) Int. Cl. G06F 3/0482

(52) U.S. Cl. CPC G06F 3/0482; G06F 2203/04803

(57) ABSTRACT

A split screen application matching method, including acquiring feature information associated with a first application, based on receiving a split screen instruction; determining a candidate application list using an artificial intelligence model based on the feature information, wherein the artificial intelligence model comprises a feature extraction model and a deep learning model, and the candidate application list comprises at least one candidate second application; and displaying the first application in a first split screen area of the terminal, and displaying the candidate application list in a second split screen area of the terminal.

### CROSS-REFERENCE TO RELATED APPLICATION

This application is a continuation application of International Application No. PCT/KR2023/014385, filed on Sep. 21, 2023, which is based on and claims priority to Chinese Patent Application No. 202211152788.9 filed on Sep. 21, 2022, in the China National Intellectual Property Administration, the disclosures of which are incorporated by reference herein in their entireties.

### BACKGROUND

### 1. Field

The disclosure relates to the field of computer technology, and more specifically, to a split screen application matching method of a terminal, an apparatus, an electronic device and a storage medium.

### 2. Description of Related Art

In the process of using an electronic device such as a terminal, there may be a situation in which two different application interfaces may be displayed on a split screen. For example, a user may use a social application to communicate with other users while using a video application to watch videos.

For example, if the user starts a split screen function in the process of using a certain application, the terminal may provide an application list, and the user may select one application from among a plurality of applications included in the application list for displaying in the split screen. Also, the application list may be the same regardless of which application is currently used. However, in the split screen scene, there may be a certain correlation between the application currently opened and the application to be opened, but the application list provided by the terminal may not change based on the application currently opened, resulting in candidate applications being displayed which are not the desired applications of the user, and thus the effect of recommending the split screen application is poor.

### SUMMARY

Provided is a split screen application matching method of a terminal, apparatus, electronic device and storage medium, to at least solve the problem of the poor effect of recommending the split screen application in the above related technology.

Additional aspects will be set forth in part in the description which follows and, in part, will be apparent from the description, or may be learned by practice of the presented embodiments.

In accordance with an aspect of the disclosure, a split screen application matching method includes acquiring feature information associated with a first application, based on receiving a split screen instruction A split screen application matching method includes determining a candidate application list using an artificial intelligence model based on the feature information, wherein the artificial intelligence model comprises a feature extraction model and a deep learning model, and the candidate application list comprises at least one candidate second application. A split screen application matching method includes displaying the first application in a first split screen area of the terminal, and displaying the candidate application list in a second split screen area of the terminal.

In accordance with an aspect of the disclosure, a split screen application matching apparatus includes a feature information acquiring module configured to acquire feature information associated with a first application, based on receiving a split screen instruction. A split screen application matching apparatus includes a candidate application list determination module configured to determine a candidate application list using an artificial intelligence model based on the feature information, wherein the artificial intelligence model comprises a feature extraction model and a deep learning model, and the candidate application list comprises at least one candidate second application. A split screen application matching apparatus includes. A split screen application matching apparatus includes a display module configured to display the first application in a first split screen area of a terminal, and to display the candidate application list in a second split screen area of the terminal.

In accordance with an aspect of the disclosure, an electronic device includes a memory configured to store instructions. An electronic device includes a processor configured to execute the instructions to: acquire feature information associated with a first application, based on receiving a split screen instruction; determine a candidate application list using an artificial intelligence model based on the feature information, wherein the artificial intelligence model comprises a feature extraction model and a deep learning model, and the candidate application list comprises at least one candidate second application; and display the first application in a first split screen area of a terminal, and displaying the candidate application list in a second split screen area of the terminal.

In accordance with an aspect of the disclosure, a computer-readable storage medium stores instructions which, when executed by a processor of an electronic device, cause the electronic device to acquire feature information associated with a first application, based on receiving a split screen instruction. A computer-readable storage medium stores instructions which, when executed by a processor of an electronic device, cause the electronic device to determine a candidate application list using an artificial intelligence model based on the feature information, wherein the artificial intelligence model comprises a feature extraction model and a deep learning model, and the candidate application list comprises at least one candidate second application. A computer-readable storage medium stores instructions which, when executed by a processor of an electronic device, cause the electronic device to display the first application in a first split screen area of a terminal, and displaying the candidate application list in a second split screen area of the terminal.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a split screen application matching method of a terminal according to an exemplary embodiment of the disclosure;

FIG. 2 is a schematic diagram illustrating a real behavior sequence according to an exemplary embodiment of the disclosure;

FIG. 3 illustrates an application relationship graph according to an exemplary embodiment of the disclosure;

FIG. 4 is a schematic diagram illustrating a plurality of application sequences according to an exemplary embodiment of the disclosure;

FIG. 5 is a schematic diagram illustrating a CBOW and a Skip-gram according to an exemplary embodiment of the disclosure;

FIG. 6 is a schematic diagram illustrating a model training and a model service according to an exemplary embodiment of the disclosure;

FIG. 7 is a schematic diagram illustrating a further optimization of the artificial intelligence comprehensive model of the disclosure according to an exemplary embodiment of the disclosure;

FIG. 8 is a structural schematic diagram illustrating a Gated Recurrent Unit (GRU) according to an exemplary embodiment of the disclosure;

FIG. 9 is a schematic diagram illustrating a display of split screen applications according to an exemplary embodiment of the disclosure;

FIG. 10 is a schematic diagram illustrating another display of split screen applications according to an exemplary embodiment of the disclosure;

FIG. 11 is a schematic diagram illustrating example reasons for selecting each of a plurality of applications a second application corresponding to a social application according to an exemplary embodiment of the disclosure;

FIG. 12 is a block diagram illustrating a split screen application matching apparatus according to an exemplary embodiment of the disclosure; and

FIG. 13 is a block diagram illustrating an electronic device according to an exemplary embodiment of the disclosure.

### DETAILED DESCRIPTION

Hereinafter, embodiments will be described in detail with reference to the accompanying drawings.

As is traditional in the field, embodiments may be described and illustrated in terms of blocks which carry out a described function or functions. These blocks, as shown in the drawings, which may be referred to herein as “units” or “modules” or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

The terms “first”, “second” and the like in the description and claims and the above drawings of the disclosure may be used to distinguish similar objects, and are not necessarily used to describe a specific order or precedence sequence. It should be understood that the data so used may be exchanged where appropriate, so that the embodiment of the disclosure described herein can be implemented in an order other than those illustrated or described herein. The implementations described in the following embodiments do not represent all embodiments consistent with the disclosure, but instead are examples consistent with aspects of the disclosure.

The phrase “at least one of several items” appearing in the disclosure may have one or more of three types of parallel meaning: “any one of the several items”, “combination of any items of the several items”, and “all of the several items”. For example, the phrase “including at least one of A and B” may include the following three parallel meanings: (1) including A; (2) including B; (3) including A and B. For another example, “performing at least one of step 1 and step 2” may include the following three parallel cases: (1) performing step 1; (2) performing step 2; (3) performing steps 1 and 2.

In a split screen scene, an application currently opened and an application soon to be opened are often not independent, but instead have a certain association. For example, when reading news using a news-type application (which may be referred to as an “APP”), a user may want to record interesting news, at this time, the application which the user wants to use in split screen may be a memo application; or, when the user chats using a social application, which may be for example a chat application or a social media application, if tourism topics are involved, the application that the user wants to use in split screen may be a travel application. However, the application list provided in the related technology will not change with the difference of the application currently opened, resulting in that the candidate applications displayed are not the ones that the user really want to use in split screen, and the effect of recommending the split screen application is poor.

In order to solve the above problems, embodiments may provide a split screen application matching method which may determine a candidate application list by an artificial intelligence (AI) comprehensive model, based on feature information associated with a first application, which may ensure that there is a high probability that the displayed candidate applications are the applications that the user really wants to use in split screen, and that the effect of recommending the split screen application is improved.

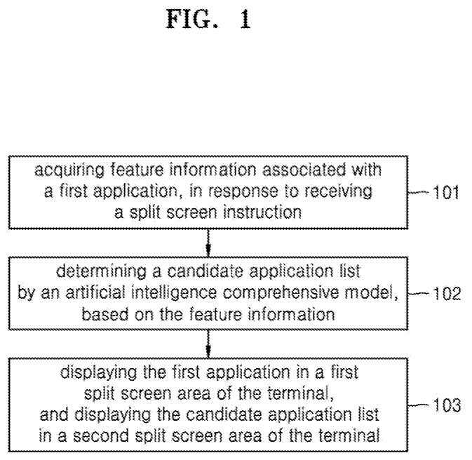

FIG. 1 is a flowchart illustrating a split screen application matching method of a terminal according to an exemplary embodiment of the disclosure.

Referring to FIG. 1, in step 101, feature information associated with a first application may be acquired, in response to receiving a split screen instruction. For example, in the case where the first application in the terminal is in a started state or a running state, the feature information associated with the first application may be acquired, in response to receiving the split screen instruction.

According to an embodiment of the disclosure, the feature information associated with an first application may include: identification information of the first application, identification information of a third application (or a plurality of third applications), identification information of an application (or applications) currently installed on the terminal, and/or a keyword (or keywords) of the first application, wherein the third application is an application used at the time adjacent to the time when the first application is currently used, and the applications currently installed are applications installed in the terminal at the time when the first application is currently used.

In embodiments, the identification information of the applications may be application identifiers (IDs). For example, a number such as 10000 or 50000 application programs commonly used may be collected. Then, an application ID may be generated for each application program, and the application IDs of different applications may be different.

According to an exemplary embodiment of the disclosure, an App2Vec model may be provided, which may be used to convert the identification information of the application, that is, the application ID, into a feature vector of the application. In embodiments, the App2Vec model may be an AI model, for example a machine learning model or a neural network model, which may perform at least one of an application vectorization process and an application embedding process. When training the App2Vec model, a DeepWalk method may be combined, which is a Graph Embedding method. A main idea of the DeepWalk may be to perform random walks on a graph structure including applications, generate a large number of application sequences, and then generate a large number of training samples by using the application sequences. Next, the generated training samples may be input into the App2Vec model to train the App2Vec model.

According to an embodiment of the disclosure, in the case where the feature extraction model is the App2Vec model, the App2Vec model may be obtained by being trained based on a plurality of real behavior sequences of each user among a plurality of users, wherein the real behavior sequences may include at least two applications that are used sequentially in the real scene.

The real scene can mean the screen of a terminal which is not split.

As an example, the App2Vec model may be trained by the following steps:

First, a plurality of application sequences may be acquired. Then, a plurality of training sample groups corresponding to each of the plurality of application sequences may be acquired. Wherein each training sample group may contain a plurality of training samples, and each training sample may contain a feature application and a label application.

For example, an obtained application sequence may be C->E->F->A->B->G->I->H, wherein C, E, F, A, B, G, I, H represent different applications respectively. For this application sequence, a sliding window with a length of 2c+1 may be set, For example, based on a value of c being 2, a length of the sliding window may be set to 5. Starting from a first node of the application sequence C->E->F->A->B->G->I->H, the above sliding window may be slid from left to right, and for every slide, applications contained in the sliding window form a training sample group.

For example, when the applications contained in the sliding window are C, E, F, A, B, the obtained training sample group is [C, E, F, A, B], and a plurality of training samples contained in the training sample group may be (F, C), (F, E), (F, A), (F, B), where F in the four training samples may represent the feature application, and other applications C, E, A and B in the four training samples may represent the label applications. Next, the sliding window may move to the right once, so that the applications contained in the sliding window are E, F, A, B, G, the obtained training sample group at this time is [E, F, A, B, G], and a plurality of training samples included in this training sample group may be (A, E), (A, F), (A, B), (A, G, where A in the four training samples may represent the feature application, and E, F, B and G in the four training samples may represent label applications. Accordingly, eight training sample groups may be obtained based on the application sequence C->E->F->A->B->G->I->H.

After obtaining training samples, the identification information of the feature application contained in each training sample may be input into the APP2Vec model to obtain an adjacent prediction probability corresponding to each of the plurality of applications contained in the application library. In embodiments, the adjacent prediction probability may be used to indicate the probability that the use order of the application is adjacent to the use order of the feature application.

Next, a value of a first loss function may be calculated based on the adjacent prediction probability corresponding to the label application contained in each training sample. Then, the APP2Vec model may be trained by adjusting parameters of the APP2Vec model according to a value of the first loss function.

In embodiments, the user may have rarely used or not have used split screen in the past, and the data available for reference may be too sparse. However, the DeepWalk algorithm may be used to generate a large number of training samples, and then the App2Vec model may be trained by using the generated training samples. The trained App2Vec model may extract a weak feature of “historical behavior (using applications) sequence of users in the past”, which may convert a high-dimensional sparse feature vector (application ID) into a low-dimensional dense feature vector, allowing applications that were originally independent of each other to be related with each other, and may therefore ensure that there is a high probability that the predicted split screen applications are the applications that the user really want to use in split screen.

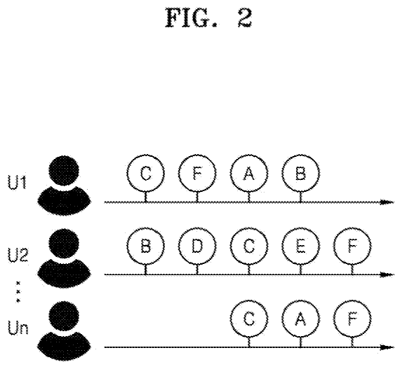

According to an exemplary embodiment of the disclosure, as described above, the plurality of real behavior sequences of each user among the plurality of users may be acquired, where the real behavior sequence may contain at least two applications that are used sequentially in the real scene. FIG. 2 is a schematic diagram illustrating a real behavior sequence according to an exemplary embodiment of the disclosure. In FIG. 2, the horizontal axis of the figure represents a sequence of applications used by a certain user in a certain time period, and the vertical axis in FIG. 2 represents collecting the real behavior sequences of n users, for example user U1, user U2, . . . , and user Un. In embodiments, n may be any number, for example 100000. For example, the real behavior sequence of a user U1, that is, the at least two applications that the user U1 sequentially uses in the real scene may be: C, F, A, B. As another example, the real behavior sequence of a user U2, that is, the at least two applications that the user 2 sequentially uses in the real scene are: B, D, C, E, F As yet another example, the real behavior sequence of a user Un, that is, the at least two applications that the user Un sequentially uses in the real scene are: C, A, F. The vertical axis in FIG. 2 represents collecting the real behavior sequences of n users, for example U1, U2, Un. In embodiments, n may be any number, for example 100000.

Next, an application relationship graph may be acquired based on the plurality of real behavior sequences of each user among the plurality of users. In embodiments the application relationship graph may contain a plurality of nodes, and each node of the plurality of nodes may correspond to a used application contained in the real behavior sequence.

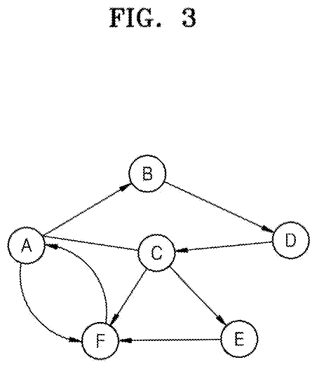

FIG. 3 illustrates an application relationship graph according to an exemplary embodiment of the disclosure. As shown in FIG. 3, the plurality of nodes may be connected by edges, and the edges between the nodes may be directed edges, which may for example mean that the direction of each directed edge is consistent with the order in which the applications included in the real behavior sequence are used. For example, the directed edge from node A directed to node B may be generated from the user U1 first using the application A and then using the application B. In addition, if multiple identical directed edges are generated, the weights of the directed edges are strengthened.

Then, a plurality of application sequences may be obtained by performing random walks between the plurality of nodes in FIG. 3. In embodiments, each application sequence may contain a node passed in the random walks process among the plurality of nodes. Because the application relationship graph in FIG. 3 belongs to a directed weighted graph, a probability of jumping from node vᵢ to node vⱼ may be defined as according to Equation 1 below:

$$\\ \begin{matrix}P ( {v}_{j} \vert {v}_{i} ) = \{ \begin{matrix}\frac{{M}_{ij}}{{\sum }_{{v}_{j} ∈ {N}_{+} ( {v}_{i} )} {M}_{ij}} , & {v}_{j} ∈ {N}_{+} ( {v}_{i} ) \\ 0 , & {e}_{ij} ∉ ε\end{matrix} & ( Equation 1 )\end{matrix}$$

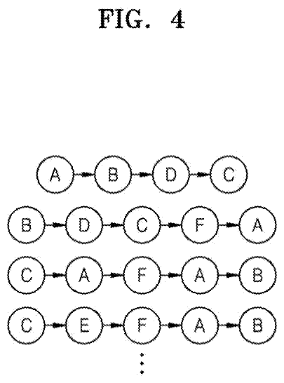

In Equation 1 above, P(vⱼ|vᵢ) may denote a probability of jumping from node vᵢ to node vⱼ, ε may denote a set of all edges in the application relationship graph, N+(vᵢ) may denote a set of all outgoing edges of node vᵢ, Mᵢⱼ may denote a weight of the edge from node vᵢ to node vⱼ, eᵢⱼ may denote an edge between nodes vᵢ and vⱼ, and eᵢⱼ ∉ε may indicate that there is no edge between node vᵢ and node vⱼ in the application relationship graph. That is, the jump probability of DeepWalk may be a ratio of a weight of the jumping edge to a sum of weights of all related outgoing edges. FIG. 4 is a schematic diagram illustrating a plurality of application sequences according to an exemplary embodiment of the disclosure. In FIG. 4, four application sequences are shown, which are A->B->D->C; B->D->C->F->A; C->A->F->A->B; C->E->F->A->B respectively.

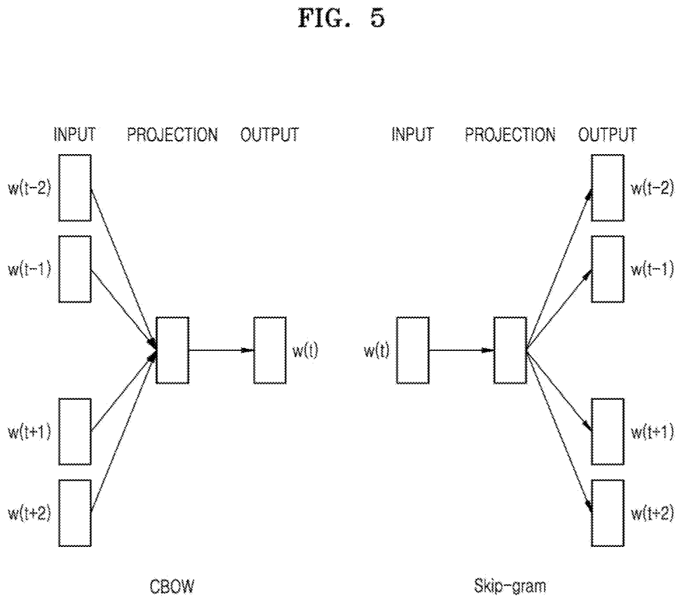

In embodiments the App2Vec model may have two model structures, which may be a Continuous Bag Of Words (CBOW) model structure and a skip-gram model structure, respectively. FIG. 5 is a schematic diagram illustrating a CBOW model structure and a skip-gram model structure according to an exemplary embodiment of the disclosure. As shown in FIG. 5, the CBOW model structure may include input layer(s) (INPUT), predicting layer(s) (PROJECTION), and output layer(s) (OUTPUT). CBOW model structures may be used to predict the application w (t) having a use order between application w(t−1) and application w(t+1) by the application w(t−2), the application w(t−1), the application w(t+1), and the application w(t+2). As further shown in FIG. 5, the skip-gram model structure may include input layer(s) (INPUT), predicting layer(s) (PROJECTION) and output layer(s) (OUTPUT). Skip-gram model structures may be used to predict the application w(t−2), application w(t−1), application w(t+1) and application w(t+2) having a use order adjacent to that of application w(t) by application w(t).

In embodiments the App2Vec model implemented using a skip-gram model structure may be used as an example to explain a process of acquiring a plurality of training sample groups corresponding to one application sequence.

According to embodiments of the disclosure, for each application sequence, starting from a first node among the plurality of nodes contained in the application sequence, each node may be used as a center node in sequence, and a preset or predetermined number of nodes adjacent to the center node in the application sequence and the center node may be determined as one training sample group among the plurality of training sample groups corresponding to the application sequence.

For example, as discussed above, for an application sequence C->E->F->A->B->G->I->H a sliding window with a length of 2c+1 may be set, where c is the preset number. For example, the value of c may be 2, and the length of the sliding window may be 5. Starting from a first node of the application sequence C->E->F->A->B->G->I->H, the above sliding window may be slid from left to right, and every slide, the applications contained in the sliding window may form a training sample group.

For example, the first node may be C, and the node C may be used as the center node, and two nodes adjacent to the center node C in the application sequence and the center node C may be determined as the first training sample group of the application sequence. Because there is no adjacent application in front of the center node C, the first training sample group may be: [C, E, F,].

Next, the sliding window may slide to the right once, so that the node E may be used as the center node, and two nodes adjacent to the center node E in the application sequence and the center node E may be determined as the second training sample group of the application sequence. Because there is only one node C in front of the center node E, the second training sample group may be: [C, E, F, A].

Then, the sliding window slides to the right again, so that the node F may be used as the center node, and two nodes adjacent to the center node F in the application sequence and the center node F may be determined as the third training sample group of the application sequence: [C, E, F, A, B].

Accordingly, eight training sample groups may be obtained based on the application sequence C->E->F->A->B->G->I->H.

According to an exemplary embodiment of the disclosure, the feature application contained in each training sample may be the center node in the training sample group to which the training sample belongs, and the label application contained in each training sample may be the nodes other than the center node in the training sample group to which the training sample belongs. For example, the training sample group [C, E, F,] may contain a plurality of training samples (C, E) and (C, F), wherein the center node C of the two training samples may be the feature application, and the other nodes E and F in the two training samples may be label applications. As another example, the training sample group [C, E, F, A] may contain a plurality of training samples (E, C), (E, F) and (E, A), wherein the center node E in the three training samples may be the feature application, and the other nodes C, F, A in the three training samples may be label applications.

According to an exemplary embodiment of the disclosure, a first loss function may be expressed by Equation 2 below:

$$\\ \begin{matrix}L 1 = \frac{1}{T} {\sum }_{t = 1}^{T} {\sum }_{- c \leq j \leq c , j \neq 0} log p ( {w}_{t + j} \vert {w}_{t} ) & ( Equation 2 )\end{matrix}$$

In Equation 2, L1 may denote the first loss function, T may denote the number of nodes included in the application sequence, wₜ may denote the feature application, wₜ₊ⱼ may denote the label application, p(wₜ₊ⱼ|iwₜ) may denote the adjacent prediction probability corresponding to the label application, t may denote the position of the feature application in the application sequence, c may denote the preset number, and t+j may denote the position of the label application in the application sequence.

According to an exemplary embodiment of the disclosure, in the case where the feature extraction model is the App2Vec model, the deep learning model may be obtained by being trained based on the trained App2Vec model, a first historical application and a second historical application used in split screen by the user of the terminal during the historical process.

As an example, the deep learning model may be trained by the following steps:

First, the first historical application and the second historical application used in split screen by the user of the terminal during the historical process may be acquired. In embodiments, the first historical application may be the application used first, and the second historical application may be the application used in split screen based on the first historical application.

Then, the identification information of the first historical application may be input into the trained APP2Vec model to obtain the feature vector of the first historical application.

Next, the feature vector of the first historical application may be input into the deep learning model to obtain the probability of each application in the application library being predicted to be selected. In embodiments, the probability of each application being predicted to be selected may be the probability of predicting the application as a split screen application of the first historical application.

Then, a value of the second loss function may be calculated based on the probability of each application being predicted to be selected and the second historical application. Next, the deep learning model may be trained by adjusting the parameters of the deep learning model according to the value of the second loss function.

In embodiments, the model training may include two parts, for example App2Vec model pre-training and deep learning model training respectively. For example, the App2Vec model may be pre-trained, and then the deep learning model may be trained based on the trained App2Vec model. The deep learning model may include three layers of full connection network and a softmax layer, wherein the three layers of full connection network may include three layers of “full connection network and ReLU excitation function”. The softmax layer may be a multi-class model, and its prediction target is the application which the user selects as the split screen application.

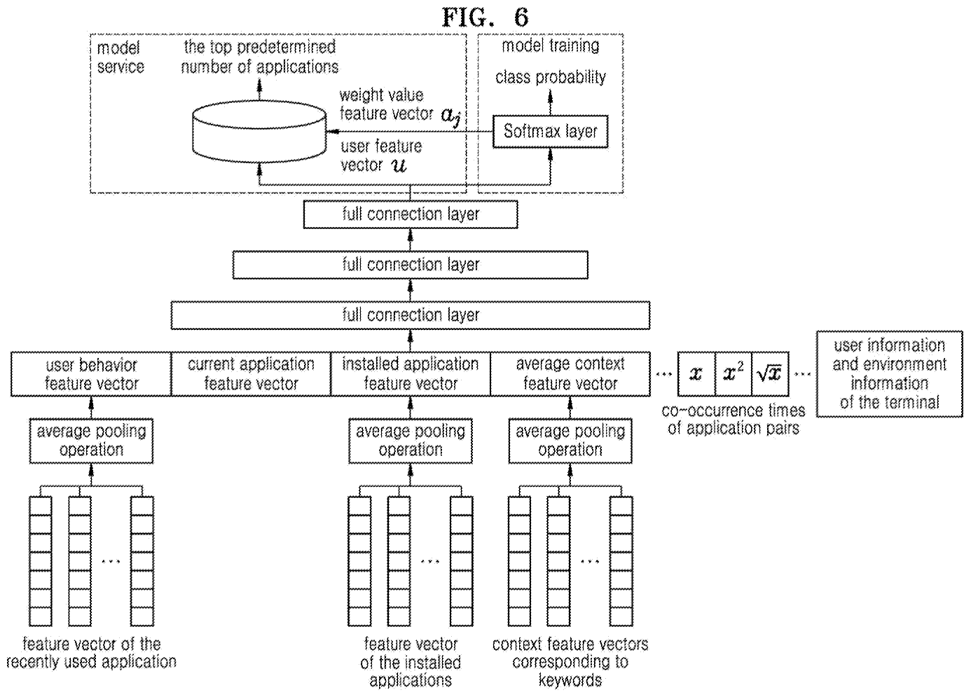

FIG. 6 is a schematic diagram illustrating a model training and a model service according to an exemplary embodiment of the disclosure. As shown in FIG. 6, a user feature vector u may be the output vector of the “three layers of full connection network+ReLU excitation function”. The input of the softmax layer may be the user feature vector u, and the output vector is the probability distribution of the user selecting each application. Because each dimension of the output vector corresponds to one application, the softmax layer column vector corresponding to the dimension may be a weight value feature vector aⱼ. The softmax layer may be expressed according to Equation 3 below:

$$\\ \begin{matrix}P ( {w}_{t} = i \vert U ) = \frac{{e}^{{a}_{i} u}}{{\sum }_{j ∈ A} {e}^{{a}_{j} u}} & ( Equation 3 )\end{matrix}$$

Class probability P(wₜ=i|U) may indicate the probability that specified applications in the application library are classified into type i based on a specific user U at time t. In embodiments, u ∈ R^{K} may represent the user feature vector, a aⱼ ∈ R^{K} may represent the weight value feature vector of the j^{th} application, aᵢ ∈ R^{K} may represent the weight value feature vector of the i^{th} application, and K may represent the dimension of the feature. The dimension of the user feature vector u and the dimension of each weight value feature vector aⱼ may be consistent, and may be for example K.

According to an exemplary embodiment of the disclosure, when training the deep learning model, at least one of the feature vector of the third historical application(s), the feature vector(s) of the historical application(s) currently installed, the context feature vector of the first historical application, the case of the first historical application being used in split screen with other application before the first historical application is used, user information and environment information of the terminal at the time of the first historical application being used may also be acquired.

In embodiments, the use time of the third historical application may be adjacent to the time of the first historical application being used, that is, the third historical application may be the “most recently used application” of the first historical application. The feature vector of the third historical application may be used to characterize applications in the application library having adjacent order of use with the third historical application, that is, the feature vector of the third historical application is obtained by inputting the identification information of the third historical application into the trained App2Vec model. The number of the third historical applications may be multiple, for example, 50 applications of which the use time is adjacent to the time of the first historical application being used may be selected as the third historical applications. When the number of third historical applications is multiple, the feature vectors of the multiple third historical applications may be used for an average pooling operation to obtain a “user behavior feature vector”, and the “user behavior feature vector” is used to train the deep learning model. Here, the function of average pooling is to reduce parameters and computation while retain main features to prevent over fitting.

The historical applications currently installed may be the applications installed in the terminal at the time when the first historical application is used. The feature vectors of the historical applications currently installed may be used to characterize applications in the application library having adjacent order of use with the historical applications currently installed. For example, the feature vectors of the historical applications currently installed may be obtained by inputting the identification information of the historical applications currently installed into the trained App2Vec model. The number of historical applications currently installed may be multiple, “feature vectors of the applications installed” may be obtained by performing an average pooling operation on the feature vectors of the multiple historical applications currently installed, and the “feature vectors of the applications installed” may be used to train the deep learning model.

The context feature vector of the first historical application may be used to characterize words in a word library having adjacent order of use with the keywords of the first historical application. For example, the context feature vector of the first historical application may be obtained by inputting the keywords of the first historical application into a Word2Vec model. In embodiments, the Word2Vec model may be an AI model, for example a machine learning model or a neural network model, which may perform at least one of a word vectorization process and a word embedding process. The number of keywords of the first historical application may be multiple, an “average context feature vector” may be obtained by performing an average pooling operation on the plurality of context feature vectors corresponding to the multiple keywords, and the “average context feature vector” may be used to train the deep learning model. In embodiments, the above keywords of the first historical application may be extracted from content contained in the application interface of the first historical application. For example, when the first historical application is the social application, the keywords may be extracted from the chat content contained in the application interface of the social application. Because not all applications have a clear keyword, the option of “the context feature vector of the first historical application” may be not used when training the deep learning model.

For the case of the first historical application being used in split screen with other application before the first historical application is used, this may be the number of times that the first historical application is used in split screen with other application within one month before the first historical application is used this time, that is, “co-occurrence times of application pairs”. This may belong to a continuous feature, which may be normalized. In addition, the nonlinear function processing method may also be used, that is, the normalized feature may be transformed directly by the nonlinear function, and then the normalized feature and the transformed feature may be added into the deep learning model for training. For example, the normalized feature “co-occurrence times of application pairs” may be x, then the features obtained by transforming via nonlinear function may be x² and \sqrt{x}, and x, where x² and \sqrt{x} may be added into the deep learning model together for training. This may be done to enrich the expression of features and improve the accuracy of the deep learning model.

In embodiments the “co-occurrence times of application pairs” may be a feature with direct significance. Due to the need to count the co-occurrence times of each application, there are problems such as sparse features and a large amount of parameters. In embodiments, the compromise between accuracy and performance may be comprehensively considered when determining whether to use this feature.

For the user information and environment information of the terminal at the time of the first historical application being used, the user information may include the user's age, gender and other information; the environmental information may include geographic location information, current time information, and so on. This feature may have relatively little impact on inter-application relevance and therefore may be not used in some embodiments.

The feature vector of the first historical application and at least one of the above options may be input into the deep learning model to obtain the probability of each application in the application library being predicted to be selected. Back to FIG. 6, in FIG. 6, when training the deep learning model, the input of the three layers of full connection network may include the feature vector of the first historical application, that is, the feature vector of the current application, may also include at least one of “user behavior feature vector”, “feature vectors of the applications installed “, “average context feature vector”, “co-occurrence times of application pairs” and “user information and environment information of the terminal”. In this way, when training the deep learning model, not only the feature vector of the first historical application may be considered, but also other aspects of information related to the first historical application may be considered, that is, multi-dimensional and more comprehensive information may be used to train the deep learning model, which may improve the accuracy of the deep learning model.

According to an exemplary embodiment of the disclosure, a second loss function may be expressed according to Equation 4 and Equation 5 below:

$$\\ \begin{matrix}L 2 = - {\sum }_{i = 1}^{A} {y}_{i} log ( {p}_{i} ) & ( Equation 4 )\end{matrix}$$

$$\\ \begin{matrix}{p}_{i} = \frac{{e}^{{a}_{i} u}}{{\sum }_{j ∈ A} {e}^{{a}_{j} u}} & ( Equation 5 )\end{matrix}$$

In Equation 4 and Equation 5 L2 may denote the second loss function, A may denote the application library, and pᵢ may denote the probability of the i^{th} application in the application library being predicted to be selected. For example, in the case that the i^{th} application is the second historical application, yᵢ=1, otherwise, yᵢ=0. In addition, aᵢ may denote the weight value feature vector of the i^{th} application, aⱼ may denote the weight value feature vector of the j^{th} application in the application library, and u may denote the user feature vector of the user of the terminal.

Returning to FIG. 1, at step 102, the candidate application list may be determined by the AI comprehensive model, based on the feature information. In embodiments, the AI comprehensive model may include a feature extraction model and a deep learning model, and the candidate application list may include at least one candidate second application.

According to an embodiment of the disclosure, the feature information vector may be obtained by the feature extraction model based on the feature information. In embodiments, the feature extraction model may include an App2Vec model and a Word2Vec model. Then, the user feature vector u and the weight value feature vector aⱼ of each application in the application library may be obtained by the deep learning model, based on the feature information vector. In embodiments, the user feature vector u may be the feature information vector that has been specially processed, and the weight value feature vector aⱼ of each application is used to characterize a weight of the application being selected as the second application. Next, the candidate application list may be determined based on the user feature vector u and the weight value feature vector aⱼ of each application.

According to an exemplary embodiment of the disclosure, the feature information vector may include a feature vector of the first application, a feature vector of the third application, feature vectors of the applications currently installed, and/or a context feature vector of the first application.

The feature vector of the first application may be obtained by the App2Vec model, based on the identification information of the first application. In embodiments, the feature vector of the first application may be used to characterize applications in the application library having adjacent order of use with the first application.

The feature vector of the third application may be obtained by the App2Vec model, based on the identification information of the third application. In embodiments, the feature vector of the third application may be used to characterize applications in the application library having adjacent order of use with the third application.

The feature vectors of the applications currently installed may be obtained by the App2Vec model, based on the identification information of the applications currently installed on the terminal. In embodiments, the feature vectors of the applications currently installed may be used to characterize applications in the application library having adjacent order of use with the applications currently installed.

In embodiments, the context feature vector of the first application may be obtained by the Word2Vec model based on the keywords of the first application. For example, the context feature vector of the first application may be used to characterize words in a word library having adjacent order of use with the keywords of the first application.

As an example, when determining the candidate application list, at least one of the case of the first application being used in split screen with other application before the first application is used, the user information and the environment information of the terminal at the time when the first application is currently used may also be acquired.

In embodiments use time of the third application may be adjacent to the time when the first application is currently used. The feature vector of the third application may be used to characterize applications in the application library having adjacent order of use with the third application, that is, the feature vector of the third application may be obtained by inputting the identification information of the third application into the trained App2Vec model.

The applications currently installed may be the applications installed in the terminal at the time when the first application is currently used. The feature vectors of the applications currently installed may be used to characterize applications in the application library having adjacent order of use with the applications currently installed, that is, the feature vectors of the applications currently installed may be obtained by inputting the identification information of the applications currently installed into the trained App2Vec model.

The context feature vector of the first application may be used to characterize words in a word library having adjacent order of use with the keywords of the first application, that is, the context feature vector of the first application may be obtained after inputting the keywords of the first application into the Word2Vec model.

The case of the first application being used in split screen with other application before the first application is used, may be the co-occurrence case of the first application and the other application before the first application is used.

In embodiments, the environmental information may include the geographic location information, the current time information, etc.

The feature vector of the first application, the feature vector of the third application, the feature vectors of the applications currently installed, the context feature vector of the first application, the case of the first application being used in split screen with other application before the first application is used, the user information and the environment information of the terminal at the time when the first application is currently used, may be input into the deep learning model, to obtain the user feature vector u and the weight value feature vector aⱼ of each application in the application library. In this way, when determining the at least one candidate second application, not only the feature vector of the first application may be input into the deep learning model, but also other aspects of information related to the first application may be input into the deep learning model. For example, the at least one candidate second application may be determined by using multi-dimensional and more comprehensive information, which may ensure that there is a high possibility that the determined at least one candidate second application is the application that the user really wants to use in split screen.

According to an embodiment of the disclosure, the feature vector of the third application may also be input into a Recurrent Neural Network for feature optimization. Next, the user feature vector u and the weight value feature vector aⱼ of each application in the application library may be obtained by the deep learning model, based on the feature vector of the first application, the feature vector of the third application which has been feature optimized, the feature vectors of the applications currently installed, and/or the context feature vector of the first application.

Furthermore, when updating the AI comprehensive model, the disclosure may adopt the method of local update. Because parameters of the App2Vec model, namely, the “Embedding layer”, may account for most of the parameters of the AI comprehensive model, it may be not suitable for frequent updates. Therefore, the frequency of App2Vec model pre-training may be set relatively low, for example, set as one or more time(s) per week or one or more time(s) per month. In embodiments, the parameters of the deep learning model, i.e., “three layers of full connection network+softmax layer” above the App2Vec model, may account for a relatively small part of the parameters of the AI comprehensive model, thus the training frequency of the deep learning model may be set relatively high, for example, set as one or more time(s) per day.

In some implementations, because the real-time nature of the split application recommendation system has a great impact on the accuracy, it may be necessary to frequently collect user data for model training, and therefore the training frequency of the model may be too high, which may use a relatively large amount of computing resources. However, according to embodiments, the requirement for the real-time nature of the AI comprehensive model may be relatively low, and therefore the aforementioned method of “local update” may already meet the actual use needs, the frequency of update may be greatly reduced, and computing resources may be saved.

In embodiments, as mentioned above, an average pooling operation may be performed on the feature vectors of the plurality of the third historical applications to obtain one “user behavior feature vector”. This method may have a flaw in that it may completely abandon the timing characteristics of the user using applications and may treat the user's recent usage history as the same, which may result in the loss of some valid information. Therefore, embodiments may also use the Recurrent Neural Network (RNN) model to extract the timing characteristics, thereby generating a new “user behavior feature vector”.

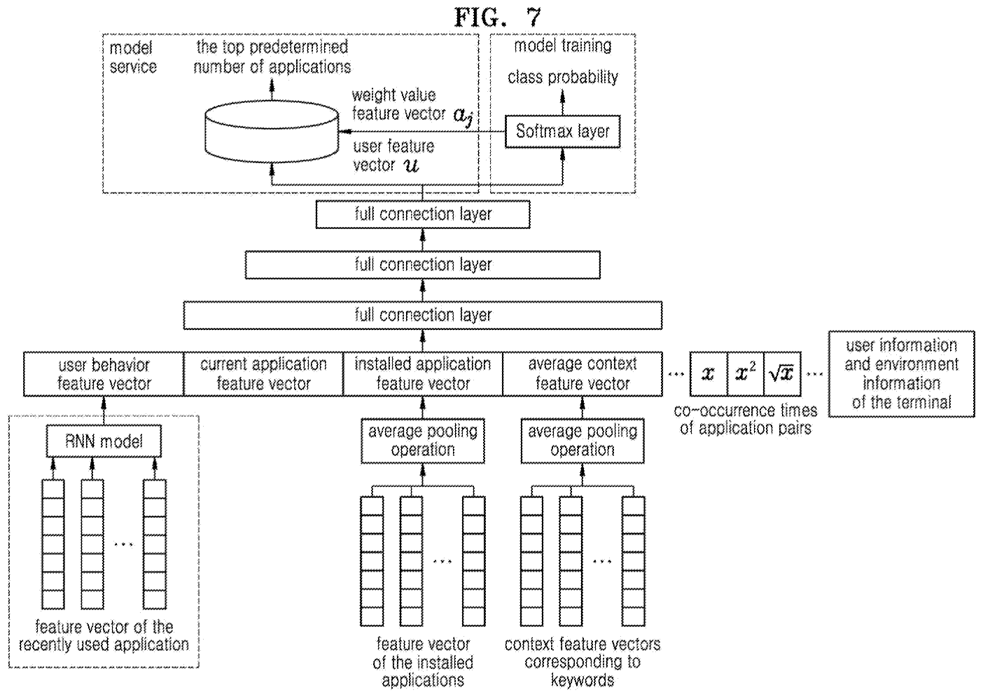

FIG. 7 is a schematic diagram illustrating a further optimization of the AI comprehensive model according to an exemplary embodiment of the disclosure. As shown in FIG. 7, the feature vectors of a plurality of applications which are recently used may be processed by the RNN model to obtain the “user behavior feature vector”.

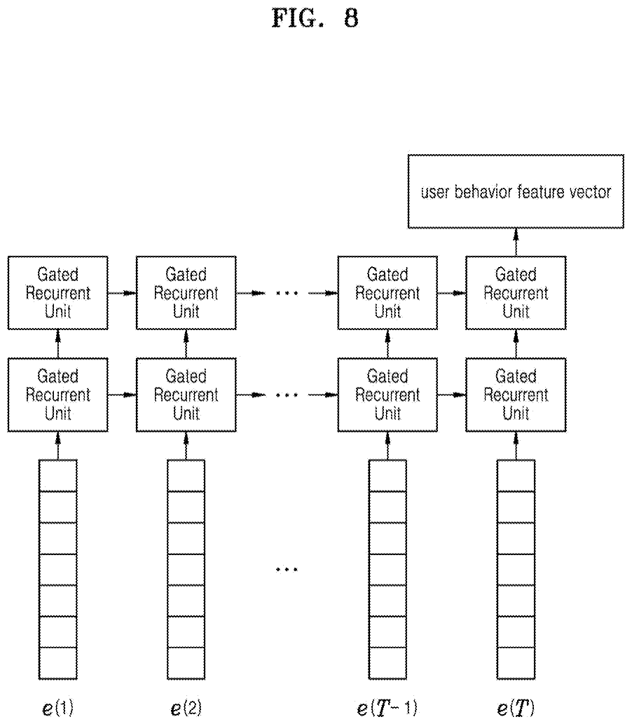

In embodiments, the RNN model may be a Gated Recurrent Unit (GRU), which may solve problems such as long-term memory and gradients in backpropagation, etc. FIG. 8 is a structural schematic diagram illustrating a Gated Recurrent Unit (GRU) according to an exemplary embodiment of the disclosure. In FIG. 8, e(1), e(2), e(T−1) and e(T) are shown, wherein e(T) represents the feature vector (Embedding) of the application recently used by the user at the time t=T.

According to an exemplary embodiment of the disclosure, the inner product of the user feature vector u and the weight value feature vectors aⱼ of the applications installed in the terminal in the application library may be calculated respectively. Next, the top predetermined number of applications with the largest inner product results among the applications installed in the terminal may be determined as the at least one candidate second application, that is, the top predetermined number of applications with the largest inner product results among the applications installed in the terminal may be determined as at least one split screen application. For example, the applications with inner product results ranking in the top 8 among the applications installed in the terminal may be determined as the split screen applications.

In embodiments, inner product operations may be not performed on all applications in the application library, for example, 10000 applications. For example, in embodiments the inner product operation may be performed only on applications currently installed by the user. For example, if the user's terminal currently has 181 applications installed, the inner product operation may be performed on the user feature vector u and weight feature vectors aⱼ of 181−1=180 applications installed except the first application APP1. In this way, computation may be reduced by orders of magnitude, which may greatly reduce the operation time and improve the response speed of the system.

The number of applications included in the application library in the disclosure may be far less than the number of applications included in, for example, some recommendation systems. In embodiments, the number of applications included in the application library may be for example between 10000 and 50000, which may include commonly used applications, and according to the actual situation, the number of applications included in the application library may even be reduced to for example 5000 to 10000. In contrast, the number of applications included in some recommendation systems may be, for example, at the level of millions or even tens of millions. Therefore, the computation of the AI comprehensive model in according to embodiments may be far less than that of some recommendation systems. In addition, as discussed above, according to embodiments, the requirement for the real-time nature of the AI comprehensive model may be relatively low, the aforementioned method of “local update” may already meet the actual use needs, the frequency of update may be greatly reduced, and computing resources may be saved. In addition, as discussed above previously, the inner product operation may be only performed on applications currently installed by the user, thus the computation may be reduced by orders of magnitude, and the operation time may be greatly reduced and the response speed of the system may be improved. Based on the above advantages, the AI comprehensive model of the disclosure may be implemented on the device side, for example, on a personal computer, mobile phone, or tablet computer of a user. Accordingly, embodiments may be used to implement on-device-AI.

Returning to FIG. 1, in step 103, the first application may be displayed in a first split screen area of the terminal, and the candidate application list may be displayed in a second split screen area of the terminal.

According to an embodiment of the disclosure, at least one of a default application list and a currently used application list may also be displayed in the second split screen area. Wherein the default application list may contain at least one preset application, and the recently used application list may contain applications of which the use time is close to the current use time of the first application APP1.

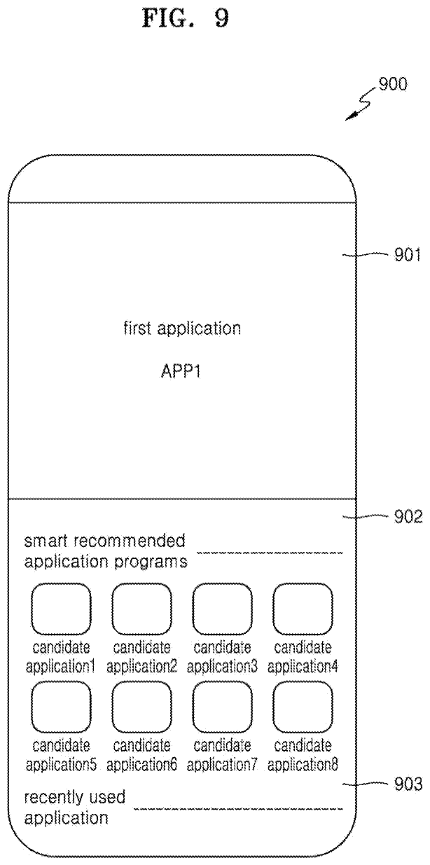

FIG. 9 is a schematic diagram illustrating a display of split screen applications according to an exemplary embodiment of the disclosure. As shown in FIG. 9, the recommended application list 903 of the at least one candidate second application APP2 arranged in order may be displayed on a screen of terminal 900. For example, the recommended application list 903 may be displayed on a second split screen portion 902 while the first application APP1 is displayed on a first split screen portion 901. The recommended application list 901 may also be called a “smart recommended application programs list”. As shown in FIG. 9, the “smart recommended application programs list” contains a total of eight candidate applications, for example candidate application 1, candidate application 2, candidate application 3, candidate application 4, candidate application 5, candidate application 6, candidate application 7, and candidate application 8. The user may slide up and down on the terminal screen to view the recently used application list and the default application list. In this way, in addition to displaying the application list of the at least one candidate second application APP2, the disclosure may also display the recently used application list and the default application list, which may expand the range of users' choices, further improves the possibility of the user selecting the application that he really want to use in split screen, and the effect of recommending the split screen application is better.

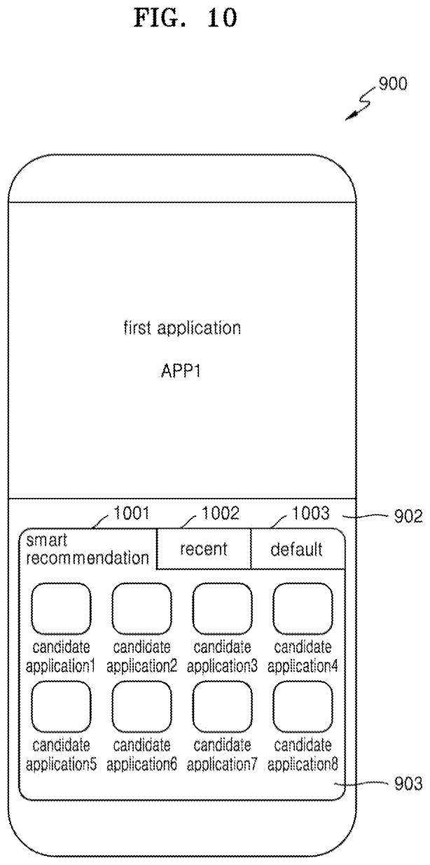

FIG. 10 is a schematic diagram illustrating another display of split screen applications according to an exemplary embodiment of the disclosure. According to an embodiment of the disclosure, tabs corresponding to at least one of the recommended application list 903, a default application list and a recently used application list may be displayed in the second split screen area. For example, the tab 1001 may correspond to the recommended application list 903, and may be labeled “smart recommendation”, the tab 1002 may correspond the recently used application list and may be labeled “recent”, and the tab 1003 may correspond to the default application list and may be labeled “default”. In embodiments the default application list may contain at least one preset application, and the recently used application list may contain applications whose use time is close to the current use time of the first application APP1. In response to the user selecting a first tab from the displayed tabs, the application list corresponding to the first tab may be displayed. In FIG. 10, the currently selected tab is the “smart recommendation” tab 1001, so the second split screen area 902 displays 8 candidate applications included in the “smart recommended application programs list”. In this way, the user may click different tabs according to his own needs, and then different application lists may be switched with each other, to find the split screen application more flexibly.

As an example, if the user has opened the split screen function and selected a certain social application as the first application APP1 for split screen, the application list of the at least one candidate second application APP2 recommended based on the AI comprehensive model of the disclosure may include the following applications: “a travel application”, “a news application”, “a video application”, “a takeaway application”, “a map application”, etc.

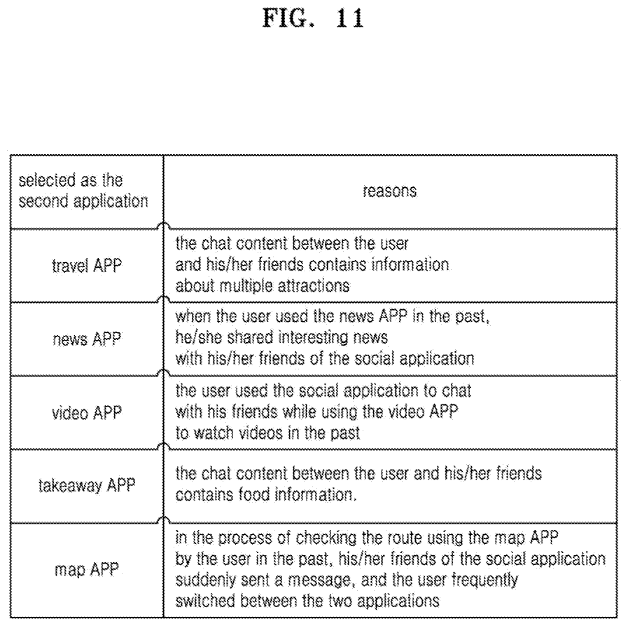

FIG. 11 is a schematic diagram illustrating reasons why each of a plurality of applications may be selected as a second application corresponding to a social application according to an exemplary embodiment of the disclosure. In embodiments, the reason why the travel application may be selected as the second application corresponding to the social application may be that: the chat content between the user and his/her friends contains information about multiple attractions; the reason why the news application may be selected as the second application corresponding to the social application may be that: when the user used the news application in the past, he/she shared interesting news with his/her friends of the social application; the reason why the video application may be selected as the second application corresponding to the social application may be that: the user used the social application to chat with his/her friends while using the video application to watch videos in the past; the reason why the takeaway application may be selected as the second application corresponding to the social application may be that: the chat content between the user and his/her friends contains food information; the reason why the map application may be selected as the second application corresponding to the social application may be that: in the process of checking the route using the map application by the user in the past, his/her friends of the social application suddenly sent a message, and the user frequently switched between the two applications.

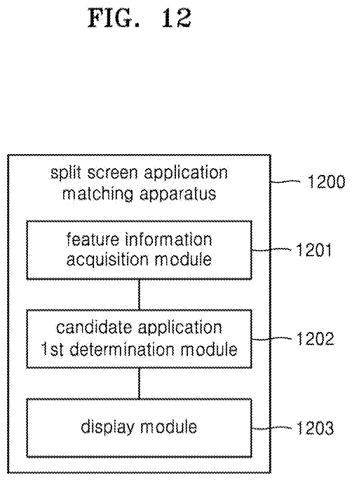

FIG. 12 is a block diagram illustrating a split screen application matching apparatus according to an exemplary embodiment of the disclosure.

Referring to FIG. 12, the apparatus 1200 may include a feature information acquisition module 1201, a candidate application list determination module 1202, and a display module 1203.

The feature information acquisition module 1201 may acquire feature information associated with a first application, in response to receiving a split screen instruction. For example, in the case where the first application in the terminal is in a started state or a running state, the feature information acquiring module 1201 may acquire the feature information associated with the first application, in response to receiving the split screen instruction.

According to an exemplary embodiment of the disclosure, the feature information associated with the first application may include: identification information of the first application, identification information of a third application, identification information of applications currently installed on the terminal, and/or keywords of the first application. In embodiments, the third application may be an application used at the time adjacent to the time when the first application is currently used, and the applications currently installed are applications installed in the terminal at the time when the first application is currently used.

In embodiments the identification information of the application may be application IDs. For example, 10000 or 50000 application programs commonly used may be collected. Then, an application ID may be generated for each application program, and the application IDs of different applications are different.

According to an exemplary embodiment of the disclosure, in the case where the feature extraction model is an App2Vec model, the App2Vec model may be obtained by training based on a plurality of real behavior sequences of each user among a plurality of users. In embodiments, the real behavior sequences may contain at least two applications that are used sequentially in a real scene. An example of a specific training process of App2Vec model has been described in detail above, and redundant description may be not repeated here.

According to an exemplary embodiment of the disclosure, in the case where the feature extraction model is an App2Vec model, the deep learning model may be obtained by training based on the trained App2Vec model, a first historical application and a second historical application used in split screen by a user of the terminal during a historical process. An example of a specific training process of the deep learning model has been described in detail above, and redundant description may not be repeated here.

The candidate application list determining module 1202 may determine a candidate application list by an AI comprehensive model, based on the feature information. In embodiments, the AI comprehensive model may include a feature extraction model and a deep learning model, and the candidate application list may include at least one candidate second application.

According to an exemplary embodiment of the disclosure, the candidate application list determining module 1202 may obtain a feature information vector by the feature extraction model, based on the feature information. Wherein the feature extraction models may include an App2Vec model and a Word2Vec model. Then, a user feature vector u and a weight value feature vector aⱼ of each application in an application library may be obtained by the deep learning model, based on the feature information vector. In embodiments the user feature vector u may be the feature information vector that has been specially processed, and the weight value feature vector aⱼ of each application is used to characterize a weight of the application being selected as the second application. Next, the candidate application list may be determined based on the user feature vector u and the weight value feature vector aⱼ of each application.

According to an exemplary embodiment of the disclosure, the feature information vector may include a feature vector of the first application, a feature vector of the third application, feature vectors of the applications currently installed, and/or a context feature vector of the first application.

The candidate application list determination module 1202 may obtain the feature vector of the first application by the App2Vec model, based on the identification information of the first application. In embodiments, the feature vector of the first application may be used to characterize applications in the application library having adjacent order of use with the first application.

The candidate application list determination module 1202 may obtain the feature vector of the third application by the App2Vec model, based on the identification information of the third application. In embodiments, the feature vector of the third application may be used to characterize applications in the application library having adjacent order of use with the third application.

The candidate application list determination module 1202 may obtain the feature vectors of the applications currently installed by the App2Vec model, based on the identification information of the applications currently installed on the terminal. In embodiments, the feature vectors of the applications currently installed may be used to characterize applications in the application library having adjacent order of use with the applications currently installed.

In embodiments, the candidate application list determination module 1202 may obtain the context feature vector of the first application by the Word2Vec model based on the keywords of the first application. In embodiments, the context feature vector of the first application may be used to characterize words in a word library having adjacent order of use with the keywords of the first application.

As an example, when determining the candidate application list, at least one the case of the first application being used in split screen with other application before the first application is used, the user information and the environment information of the terminal at the time when the first application is currently used may also be acquired, wherein:

In embodiments, the use time of the third application may be adjacent to the time when the first application is currently used. The feature vector of the third application may be used to characterize applications in the application library having adjacent order of use with the third application, that is, the feature vector of the third application is obtained by inputting the identification information of the third application into the trained App2Vec model.

The applications currently installed may be the applications installed in the terminal at the time when the first application is currently used. The feature vectors of the applications currently installed may be used to characterize applications in the application library having adjacent order of use with the applications currently installed, that is, the feature vectors of the applications currently installed may be obtained by inputting the identification information of the applications currently installed into the trained App2Vec model.

The context feature vector of the first application may be used to characterize words in a word library having adjacent order of use with the keywords of the first application, that is, the context feature vector of the first application may be obtained after inputting the keywords of the first application into the Word2Vec model.

The case of the first application being used in split screen with other application before the first application is used, may be the co-occurrence case of the first application and the other application before the first application is used.

In embodiments, the environmental information may include the geographic location information, the current time information, etc.

The feature vector of the first application, the feature vector of the third application, the feature vectors of the applications currently installed, the context feature vector of the first application, the case of the first application being used in split screen with other application before the first application is used, the user information and the environment information of the terminal at the time when the first application is currently used, may be input into the deep learning model, to obtain the user feature vector u and the weight value feature vector aⱼ of each application in the application library. In this way, when determining the at least one candidate second application, not only the feature vector of the first application may be input into the deep learning model, but also other aspects of information related to the first application may be input into the deep learning model, that is, the at least one candidate second application may be determined by using multi-dimensional and more comprehensive information, which may ensure that there is a high possibility that the determined at least one candidate second application is the application that the user really wants to use in split screen.

According to an embodiment of the disclosure, the split screen application matching apparatus 1200 may also include a feature optimization module. The feature optimization module may also input the feature vector of the third application into a Recurrent Neural Network for feature optimization. Next, the candidate application list determination module 1202 may obtain the user feature vector u and the weight value feature vector aⱼ of each application in the application library by the deep learning model, based on the feature vector of the first application, the feature vector of the third application which has been feature optimized, the feature vectors of the applications currently installed, and/or the context feature vector of the first application.

Furthermore, when updating the AI comprehensive model, the disclosure may adopt the method of local update. Because parameters of the App2Vec model, namely, the “Embedding layer”, account for most of the parameters of the AI comprehensive model, it is not suitable for frequent updates. Therefore, the frequency of App2Vec model pre-training may be set relatively low, for example, set as one or more time(s) per week or one or more time(s) per month; but the parameters of the deep learning model, i.e., “three layers of full connection network+softmax layer” above the App2Vec model, account for a relatively small part of the parameters of the AI comprehensive model, thus the training frequency of the deep learning model may be set relatively high, for example, set as one or more time(s) per day.

In some implementations, because the real-time nature of the split application recommendation system may have a great impact on the accuracy, it may be necessary to frequently collect user data for model training, which may cause the training frequency of the model to be relatively high, which may require more computing resources. However, according to embodiments, the requirement for the real-time nature of the AI comprehensive model may be relatively low, the aforementioned method of “local update” may already meet the actual use needs, the frequency of update may be greatly reduced, and computing resources may be saved.

In embodiments, as mentioned above, an average pooling operation may be performed on the feature vectors of the plurality of the third historical applications to obtain one “user behavior feature vector”. This method may have a flaw in that is may completely abandon the timing characteristics of the user using applications and treat the user's recent usage history as the same, which results in the loss of some valid information. Therefore, embodiments may also use the Recurrent Neural Network (RNN) model to extract the timing characteristics, thereby generating a new “user behavior feature vector”. Furthermore, the RNN model may be or include a GRU, which may solve problems such as long-term memory and gradients in backpropagation, etc.

According to an exemplary embodiment of the disclosure, the inner product of the user feature vector u and the weight value feature vectors aⱼ of the applications installed in the terminal in the application library may be calculated respectively. Next, the top predetermined number of applications with the largest inner product results among the applications installed in the terminal may be determined as the at least one candidate second application, that is, the top predetermined number of applications with the largest inner product results among the applications installed in the terminal may be determined as at least one split screen application. For example, the applications with inner product results ranking in the top 8 among the applications installed in the terminal may be determined as the split screen applications.

In embodiments, the inner product operation may be not performed on all applications in the application library, for example, 10000 applications, but may be only performed on applications currently installed by the user. For example, if the user's terminal currently has 181 applications installed, the inner product operation may be only performed on the user feature vector u and weight feature vectors aⱼ of 181−1=180 applications installed except the first application APP1. In this way, computation may be reduced by orders of magnitude, which may greatly reduce the operation time and improve the response speed of the system.

The number of applications included in the application library in the disclosure may be far less than the number of applications included in some recommendation systems. In embodiments, the number of applications included in the application library may be between 10000 and 50000, which may cover commonly used applications, and according to the actual situation, the number of applications included in the application library may even be reduced to 5000 to 10000. However, the number of applications included in some recommendation systems may generally be at the level of millions or even tens of millions. Therefore, the computation of the AI comprehensive model according to embodiments may be far less than that of some recommendation systems. In addition, as discussed above, the requirement for the real-time nature of the AI comprehensive model may be not high, the aforementioned method of “local update” may already meet the actual use needs, the frequency of update may be greatly reduced, and computing resources may be saved. Furthermore, as discussed above, the inner product operation may only be performed on applications currently installed by the user, thus the computation may be reduced by orders of magnitude, and the operation time may be greatly reduced and the response speed of the system is improved. Based on the above advantages, the AI comprehensive model according to embodiments may be implemented on the device side, for example on a mobile phone side/tablet side, such that embodiments may implement on-device-AI.

Returning to FIG. 11, the display module 1203 may display the first application in the first split screen area of the terminal, and may display the candidate application list in the second split screen area of the terminal.

According to an embodiment of the disclosure, the display module 1203 may also display at least one of a default application list and a currently used application list, in the second split screen area. In embodiments, the default application list may contain at least one preset or predetermined application, and the recently used application list may contain applications of which the use time is close to the current use time of the first application APP1. In this way, in addition to displaying the application list of the at least one candidate second application APP2, embodiments may also display the recently used application list and the default application list, which may expand the range of users' choices, further improve the possibility of the user selecting the application which the user really wants to use in split screen, and the effect of recommending the split screen application may be improved.

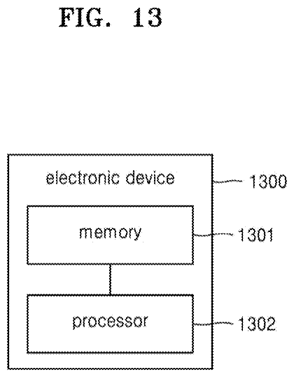

FIG. 13 is a block diagram illustrating an electronic device 1300 according to an exemplary embodiment of the disclosure.

With reference to FIG. 13, the electronic device 1300 may include at least one memory 1301 and at least one processor 1302, the at least one memory 1301 may store instructions, which when executed by the at least one processor 1302, may cause the processor to perform the split screen application matching method of the terminal according to an embodiment of the disclosure.

As an example, the electronic device 1300 may be a personal computer (PC), a tablet apparatus such as a tablet computer or a tablet PC, a personal digital assistant, a smart phone, or other apparatus capable of executing the above instructions. Here, the electronic device 1300 may not be a single electronic device, and may also be an aggregation or combination of any apparatus or circuit which may independently or jointly execute the above instructions (or instruction set). The electronic device 1300 may also be a part of an integrated control system or a system manager, or may be configured as a portable electronic device that interfaces with a local or remote (e.g., via wireless transmission).

In the electronic device 1300, the processor 1302 may include a cental processing unit (CPU), a graphics processing unit (GPU), a programmable logic apparatus, a dedicated processor system, a microcontroller, or a microprocessor. As an example, but not as a limitation, the processors may also include an analog processor, a digital processor, a microprocessor, a multi-core processor, a processor array, a network processor, and the like.

The processor 1302 may run instructions or codes stored in the memory 1301, which may also store data. Instructions and data may also be sent and received through the network via a network interface apparatus, which may employ any known transmission protocol.

The memory 1301 may be integrated with the processor 1302, for example, RAM or flash memory may be arranged within an integrated circuit microprocessor or the like. In addition, the memory 1301 may include independent apparatus, such as an external disk driver, a storage array, or other storage apparatus that may be used by any database system. The memory 1301 and the processor 1302 may be operatively coupled, or may communicate with each other, for example, through I/O ports, network connections, and the like, so that the processor 1302 can read files stored in the memory.

In addition, the electronic device 1300 may also include a video display (e.g., a liquid crystal display) and a user interaction interface (e.g., a keyboard, a mouse, a touch input apparatus, etc.). One or more components of electronic device 1300 may be connected to each other via a bus and/or the network.

According to an exemplary embodiment of the disclosure, a computer-readable storage medium may also be provided, instructions in the computer-readable storage medium, when being executed by a processor of an electronic device, cause the electronic device to perform the above split screen application matching method of the terminal. Examples of computer-readable storage media herein include: a read-only memory (ROM), a random access programmable read-only memory (PROM), an electrically erasable programmable read-only memory (EEPROM), a random access memory (RAM), a dynamic random access memory (DRAM), a static random access memory (SRAM), a flash memory, a non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu ray or optical disk memory, hard disk driver (HDD), solid state disk (SSD), card type memory (such as multimedia card, security digital (SD) card or extreme digital (XD) card), tape, floppy disk, magneto-optical data storage apparatus, optical data storage apparatus, hard disk, solid state disk and any other apparatus configured to store computer programs and any associated data, data files and data structures in a non-temporary manner and provide the computer programs and any associated data, data files and data structures to the processor or the computer so that the processor or the computer can execute the computer programs. The computer programs in the computer-readable storage medium described above may run in an environment deployed in a computer device such as a client, host, agent apparatus, server, etc. In addition, in one example, the computer programs and any associated data, data files, and data structures are distributed on a networked computer system, so that the computer programs and any associated data, data files, and data structures are stored, accessed, and executed in a distributed manner by one or more processors or computers.

According to the split screen application matching method of the terminal, apparatus, electronic device and storage medium of the disclosure, the candidate application list may be determined by the AI comprehensive model, based on the feature information associated with the first application, which may ensure that there is a high probability that the displayed candidate applications are the applications that the user really wants to use in split screen, and that the effect of recommending the split screen application is good.

Further, the DeepWalk algorithm may be used to generate a large number of training samples, and then the generated training samples may be used to train the App2Vec model. The trained App2Vec model may extract such a weak feature of “historical behavior sequence of using applications by users in the past”, which may convert a high-dimensional sparse feature vector (APP IDs) into a low-dimensional dense feature vector, allow applications that were originally independent of each other to be related with each other, and may ensure that there is a high probability that the predicted split screen applications are the applications that the user really want to use in split screen.

In embodiments, when training the deep learning model, in addition to the feature vector of the first historical application, other aspects of information related to the first historical application may be considered. For example, multi-dimensional and more comprehensive information may be used to train the deep learning model, which may improve the accuracy of the deep learning model.

Furthermore, according to embodiments, the requirement for the real-time nature of the AI comprehensive model may be relatively low, the aforementioned method of “local update” may already meet the actual use needs, the frequency of update may be greatly reduced, and computing resources may be saved.

Furthermore, when determining the at least one candidate second application, the feature vector of the first application may be input into the deep learning model, in addition to other aspects of information related to the first application. For example, the at least one candidate second application may be determined using multi-dimensional and more comprehensive information, which may ensure that there is a high possibility that the determined at least one candidate second application may be the application that the user really wants to use in split screen.

Furthermore, according to embodiments, the inner product operation may be not performed on all applications in the application library. Accordingly, the inner product operation may be only performed on applications currently installed by the user. Computation may be reduced by orders of magnitude, and the operation time may be greatly reduced and the response speed of the system is improved.

Furthermore, in addition to displaying the application list of the at least one candidate second application APP2, embodiments may also display the recently used application list and the default application list, which may expand the range of users' choices, further improve the possibility of the user selecting the application that he really want to use in split screen, and the effect of recommending the split screen application may be improved.

Furthermore, the user may select different tabs according to the user's own needs, and then different application lists may be switched with each other, to allow the user find the split screen application more flexibly.

In accordance with an aspect of the disclosure, a split screen application matching method includes acquiring feature information associated with a first application, based on receiving a split screen instruction; determining a candidate application list using an artificial intelligence model based on the feature information, wherein the artificial intelligence model comprises a feature extraction model and a deep learning model, and the candidate application list comprises at least one candidate second application; and displaying the first application in a first split screen area of the terminal, and displaying the candidate application list in a second split screen area of the terminal.

The feature information associated with the first application comprises at least one from among identification information indicating the first application, identification information indicating a third application, identification information indicating installed applications, and keywords corresponding to the first application, wherein the third application is used at a time which is adjacent to a time at which the first application is currently used, and wherein the installed applications are installed in the terminal at the time at which the first application is currently used.

The determining of the candidate application list comprises obtaining a feature information vector using the feature extraction model based on the feature information, wherein the feature extraction model comprises at least one of an App2Vec model and a Word2Vec model, obtaining a user feature vector and a weight value feature vector corresponding to each application in an application library using the deep learning model based on the feature information vector, wherein the user feature vector comprises a specially processed feature vector, and the weight value feature vector corresponding to the each application characterizes a weight of the each application, determining the candidate application list, based on the user feature vector and the weight value feature vector corresponding to the each application.

The feature information vector comprises at least one of a feature vector corresponding to the first application, a feature vector corresponding to the third application, feature vectors corresponding to the installed applications, and a context feature vector corresponding to the first application, wherein the obtaining of the feature information vector comprises obtaining the feature vector corresponding to the first application using the APP2Vec model based on the identification information indicating the first application, wherein the feature vector corresponding to the first application characterizes applications in the application library having adjacent order of use with the first application, obtaining the feature vector corresponding to the third application using the APP2Vec model based on the identification information indicating the third application, wherein the feature vector corresponding to the third application characterizes applications in the application library having adjacent order of use with the third application, obtaining the feature vectors corresponding to the installed applications using the APP2Vec model based on the identification information indicating the installed applications, wherein the feature vectors corresponding to the installed applications characterize applications in the application library having an adjacent order of use with the installed applications and obtaining the context feature vector corresponding to the first application using the Word2Vec model based on the keywords of the first application, wherein the context feature vector corresponding to the first application characterizes words in a word library having adjacent order of use with the keywords of the first application.

Before the obtaining of the user feature vector and the weight value feature vector, the method further comprises inputting the feature vector corresponding to the third application into a recurrent neural network to obtain a feature-optimized feature vector, wherein the obtaining of the user feature vector and the weight value feature vector comprises obtaining the user feature vector and the weight value feature vector corresponding to the each application in the application library using the deep learning model, based on at least one of the feature vector corresponding to the first application, the feature-optimized feature vector, the feature vectors corresponding to the installed applications, and the context feature vector corresponding to the first application.

Based on the feature extraction model being an App2Vec model, the App2Vec model is obtained by training based on a plurality of real behavior sequences corresponding to each user from among a plurality of users, and wherein each of the plurality of real behavior sequences comprise at least two applications which are used sequentially in a real scene.

Based on the feature extraction model being an App2Vec model, the deep learning model is obtained by training based on the trained App2Vec model, and a first historical application and a second historical application used in split screen by a user of the terminal during a historical process.

The displaying of the candidate application list in the second split screen area of the terminal further comprises displaying at least one of a default application list and a currently-used application list in the second split screen area.

In accordance with an aspect of the disclosure, a split screen application matching apparatus includes a feature information acquiring module configured to acquire feature information associated with a first application, based on receiving a split screen instruction; a candidate application list determination module configured to determine a candidate application list using an artificial intelligence model based on the feature information, wherein the artificial intelligence model comprises a feature extraction model and a deep learning model, and the candidate application list comprises at least one candidate second application; and a display module configured to display the first application in a first split screen area of a terminal, and to display the candidate application list in a second split screen area of the terminal.

The feature information associated with the first application comprises at least one from among identification information indicating the first application, identification information indicating a third application, identification information indicating installed applications, and keywords corresponding to the first application, wherein the third application is used at a time adjacent to a time at which the first application is currently used, and wherein the installed applications are installed in the terminal at the time at which the first application is currently used.

The candidate application list determination module is further configured to obtain a feature information vector using the feature extraction model, based on the feature information, wherein the feature extraction model comprises at least one of an App2Vec model and a Word2Vec model, obtain a user feature vector and a weight value feature vector corresponding to each application in an application library using the deep learning model, based on the feature information vector, wherein the user feature vector comprises a specially processed feature vector, and the weight value feature vector corresponding to each application characterizes a weight of the application being selected as a second application, determine the candidate application list, based on the user feature vector and the weight value feature vector corresponding to each application.

The feature information vector comprises at least one of a feature vector corresponding to the first application, a feature vector corresponding to the third application, feature vectors corresponding to the installed applications, and a context feature vector corresponding to the first application, wherein the candidate application list determination module is further configured to obtain the feature vector corresponding to the first application using the APP2Vec model, based on the identification information indicating the first application, wherein the feature vector corresponding to the first application characterizes applications in the application library having adjacent order of use with the first application, obtain the feature vector corresponding to the third application using the APP2Vec model, based on the identification information indicating the third application, wherein the feature vector corresponding to the third application characterizes applications in the application library having adjacent order of use with the third application, obtain the feature vectors of the installed applications by the APP2Vec model, based on at least one of the identification information indicating the installed applications, wherein the feature vectors of the installed applications characterize applications in the application library having adjacent order of use with the installed applications and obtain the context feature vector corresponding to the first application by the Word2Vec model based on the keywords of the first application, wherein the context feature vector corresponding to the first application characterizes words in a word library having adjacent order of use with the keywords of the first application.

The split screen application matching device further comprises a feature optimization module configured to input the feature vector corresponding to the third application into a recurrent neural network to obtain a feature-optimized feature vector, wherein the candidate application list determination module is further configured to obtain the user feature vector and the weight value feature vector corresponding to the each application in the application library using the deep learning model, based on at least one of the feature vector corresponding to the first application, the feature-optimized feature vector, the feature vectors corresponding to the installed applications, and the context feature vector corresponding to the first application.

Based on the feature extraction model being an App2Vec model, the App2Vec model is obtained by training based on a plurality of real behavior sequences corresponding to each user from among a plurality of users, and wherein each of the plurality of real behavior sequences comprises at least two applications which are used sequentially in a real scene.

Based on the feature extraction model being an App2Vec model, the deep learning model is obtained by training based on the trained App2Vec model, and a first historical application and a second historical application used in split screen by a user of the terminal during a historical process.

The display module is further configured to display at least one of a default application list and a currently-used application list in the second split screen area.

In accordance with an aspect of the disclosure, an electronic device includes a memory configured to store instructions; and a processor configured to execute the instructions to: acquire feature information associated with a first application, based on receiving a split screen instruction; determine a candidate application list using an artificial intelligence model based on the feature information, wherein the artificial intelligence model comprises a feature extraction model and a deep learning model, and the candidate application list comprises at least one candidate second application; and display the first application in a first split screen area of a terminal, and displaying the candidate application list in a second split screen area of the terminal.

In accordance with an aspect of the disclosure, a computer-readable storage medium stores instructions which, when executed by a processor of an electronic device, cause the electronic device to: acquire feature information associated with a first application, based on receiving a split screen instruction; determine a candidate application list using an artificial intelligence model based on the feature information, wherein the artificial intelligence model comprises a feature extraction model and a deep learning model, and the candidate application list comprises at least one candidate second application; and display the first application in a first split screen area of a terminal, and displaying the candidate application list in a second split screen area of the terminal.

After considering embodiments described herein, those skilled in the art will appreciate that many modifications are possible without departing from the scope of the disclosure. The disclosure is intended to cover any variant, use or adaptive change of the disclosure, the variant, use or adaptive change follows general principles of the disclosure and includes the common general knowledge or commonly used technical practices in the relevant arts. The description and embodiments are only regarded as examples, and the scope and spirit of the disclosure are pointed out in the following claims.

It should be understood that the disclosure is not limited to the precise structures already described above and shown in the drawings, and various modifications and changes may be made without departing from its scope, as defined by the appended claims.

What is claimed is:

1. A split screen application matching method of a terminal, comprising:
acquiring feature information associated with a first application, based on receiving a split screen instruction;
determining a candidate application list using an artificial intelligence model based on the feature information, wherein the artificial intelligence model comprises a feature extraction model and a deep learning model, and the candidate application list comprises at least one candidate second application; and
displaying the first application in a first split screen area of the terminal, and displaying the candidate application list in a second split screen area of the terminal.

2. The split screen application matching method of claim 1, wherein the feature information associated with the first application comprises at least one from among identification information indicating the first application, identification information indicating a third application, identification information indicating installed applications, and keywords corresponding to the first application,
wherein the third application is used at a time which is adjacent to a time at which the first application is currently used, and
wherein the installed applications are installed in the terminal at the time at which the first application is currently used.

3. The split screen application matching method of claim 2, wherein the determining of the candidate application list comprises:
obtaining a feature information vector using the feature extraction model based on the feature information, wherein the feature extraction model comprises at least one of an App2Vec model and a Word2Vec model;
obtaining a user feature vector and a weight value feature vector corresponding to each application in an application library using the deep learning model based on the feature information vector, wherein the user feature vector comprises a specially processed feature vector, and the weight value feature vector corresponding to the each application characterizes a weight of the each application;
determining the candidate application list, based on the user feature vector and the weight value feature vector corresponding to the each application.

4. The split screen application matching method of claim 3, wherein the feature information vector comprises at least one of a feature vector corresponding to the first application, a feature vector corresponding to the third application, feature vectors corresponding to the installed applications, and a context feature vector corresponding to the first application,
wherein the obtaining of the feature information vector comprises:
obtaining the feature vector corresponding to the first application using the APP2Vec model based on the identification information indicating the first application, wherein the feature vector corresponding to the first application characterizes applications in the application library having adjacent order of use with the first application;
obtaining the feature vector corresponding to the third application using the APP2Vec model based on the identification information indicating the third application, wherein the feature vector corresponding to the third application characterizes applications in the application library having adjacent order of use with the third application;
obtaining the feature vectors corresponding to the installed applications using the APP2Vec model based on the identification information indicating the installed applications, wherein the feature vectors corresponding to the installed applications characterize applications in the application library having an adjacent order of use with the installed applications; and
obtaining the context feature vector corresponding to the first application using the Word2Vec model based on the keywords of the first application, wherein the context feature vector corresponding to the first application characterizes words in a word library having adjacent order of use with the keywords of the first application.

5. The split screen application matching method of claim 4, wherein before the obtaining of the user feature vector and the weight value feature vector, the method further comprises inputting the feature vector corresponding to the third application into a recurrent neural network to obtain a feature-optimized feature vector,
wherein the obtaining of the user feature vector and the weight value feature vector comprises obtaining the user feature vector and the weight value feature vector corresponding to the each application in the application library using the deep learning model, based on at least one of the feature vector corresponding to the first application, the feature-optimized feature vector, the feature vectors corresponding to the installed applications, and the context feature vector corresponding to the first application.

6. The split screen application matching method of claim 1, wherein based on the feature extraction model being an App2Vec model, the App2Vec model is obtained by training based on a plurality of real behavior sequences corresponding to each user from among a plurality of users, and
wherein each of the plurality of real behavior sequences comprise at least two applications which are used sequentially in a real scene.

7. The split screen application matching method of claim 1, wherein based on the feature extraction model being an App2Vec model, the deep learning model is obtained by training based on the trained App2Vec model, and a first historical application and a second historical application used in split screen by a user of the terminal during a historical process.

8. The split screen application matching method of claim 1, wherein the displaying of the candidate application list in the second split screen area of the terminal further comprises:
displaying at least one of a default application list and a currently-used application list in the second split screen area.

9. A split screen application matching apparatus, comprising:
a feature information acquiring module configured to acquire feature information associated with a first application, based on receiving a split screen instruction;
a candidate application list determination module configured to determine a candidate application list using an artificial intelligence model based on the feature information, wherein the artificial intelligence model comprises a feature extraction model and a deep learning model, and the candidate application list comprises at least one candidate second application; and
a display module configured to display the first application in a first split screen area of a terminal, and to display the candidate application list in a second split screen area of the terminal.

10. The split screen application matching apparatus of claim 9, wherein the feature information associated with the first application comprises at least one from among identification information indicating the first application, identification information indicating a third application, identification information indicating installed applications, and keywords corresponding to the first application,
wherein the third application is used at a time adjacent to a time at which the first application is currently used, and
wherein the installed applications are installed in the terminal at the time at which the first application is currently used.

11. The split screen application matching apparatus of claim 10, wherein the candidate application list determination module is further configured to:
obtain a feature information vector using the feature extraction model, based on the feature information, wherein the feature extraction model comprises at least one of an App2Vec model and a Word2Vec model;
obtain a user feature vector and a weight value feature vector corresponding to each application in an application library using the deep learning model, based on the feature information vector, wherein the user feature vector comprises a specially processed feature vector, and the weight value feature vector corresponding to each application characterizes a weight of the application being selected as a second application;
determine the candidate application list, based on the user feature vector and the weight value feature vector corresponding to each application.

12. The split screen application matching apparatus of claim 11, wherein the feature information vector comprises at least one of a feature vector corresponding to the first application, a feature vector corresponding to the third application, feature vectors corresponding to the installed applications, and a context feature vector corresponding to the first application;
wherein the candidate application list determination module is further configured to:
obtain the feature vector corresponding to the first application using the APP2Vec model, based on the identification information indicating the first application, wherein the feature vector corresponding to the first application characterizes applications in the application library having adjacent order of use with the first application;
obtain the feature vector corresponding to the third application using the APP2Vec model, based on the identification information indicating the third application, wherein the feature vector corresponding to the third application characterizes applications in the application library having adjacent order of use with the third application;
obtain the feature vectors of the installed applications by the APP2Vec model, based on at least one of the identification information indicating the installed applications, wherein the feature vectors of the installed applications characterize applications in the application library having adjacent order of use with the installed applications; and
obtain the context feature vector corresponding to the first application by the Word2Vec model based on the keywords of the first application, wherein the context feature vector corresponding to the first application characterizes words in a word library having adjacent order of use with the keywords of the first application.

13. The split screen application matching apparatus of claim 12, wherein the split screen application matching device further comprises a feature optimization module configured to input the feature vector corresponding to the third application into a recurrent neural network to obtain a feature-optimized feature vector;
wherein the candidate application list determination module is further configured to obtain the user feature vector and the weight value feature vector corresponding to the each application in the application library using the deep learning model, based on at least one of the feature vector corresponding to the first application, the feature-optimized feature vector, the feature vectors corresponding to the installed applications, and the context feature vector corresponding to the first application.

14. The split screen application matching apparatus of claim 9, wherein based on the feature extraction model being an App2Vec model, the App2Vec model is obtained by training based on a plurality of real behavior sequences corresponding to each user from among a plurality of users, and
wherein each of the plurality of real behavior sequences comprises at least two applications which are used sequentially in a real scene.

15. The split screen application matching apparatus of claim 9, wherein based on the feature extraction model being an App2Vec model, the deep learning model is obtained by training based on the trained App2Vec model, and a first historical application and a second historical application used in split screen by a user of the terminal during a historical process.

16. The split screen application matching apparatus of claim 9, wherein the display module is further configured to:
display at least one of a default application list and a currently-used application list in the second split screen area.

17. An electronic device, comprises:
a memory configured to store instructions; and
a processor configured to execute the instructions to:
acquire feature information associated with a first application, based on receiving a split screen instruction;
determine a candidate application list using an artificial intelligence model based on the feature information, wherein the artificial intelligence model comprises a feature extraction model and a deep learning model, and the candidate application list comprises at least one candidate second application; and
display the first application in a first split screen area of a terminal, and displaying the candidate application list in a second split screen area of the terminal.

18. A non-transitory computer-readable storage medium configured to store instructions which, when executed by a processor of an electronic device, cause the electronic device to:
acquire feature information associated with a first application, based on receiving a split screen instruction;
determine a candidate application list using an artificial intelligence model based on the feature information, wherein the artificial intelligence model comprises a feature extraction model and a deep learning model, and the candidate application list comprises at least one candidate second application; and
display the first application in a first split screen area of a terminal, and displaying the candidate application list in a second split screen area of the terminal.
